(19) United States
(12) Patent Application Publication
(10) Pub. No.: US 2026/0367577 A1
(43) Pub. Date: Nov. 19, 2026

(54) TRIGGERING MECHANISM FOR TRIGGERING A CLOCKWORK MECHANISM, AND TIMEPIECE COMPRISING SUCH A TRIGGERING MECHANISM

(71) Applicant: Manufacture d’Horlogerie Audemars Piguet SA, Le Brassus (CH)

(72) Inventor: Laurent CALAME, La Sagne (CH)

(21) Appl. No.: 19/155,124

(22) PCT Filed: Feb. 13, 2024
(86) PCT No.: PCT/EP2024/053608

§ 371 Date: Aug. 8, 2025

(30) Foreign Application Priority Data
Feb. 21, 2023 (EP) 23157857.6

(51) Int. Cl. G04B 27/00; G04B 19/22

(52) U.S. Cl. CPC G04B 27/007; G04B 19/22

(57) ABSTRACT

A triggering mechanism for triggering a clockwork mechanism arranged to perform a function, and a timepiece including the triggering mechanism, include a controller, a trigger wheel and pinion mounted in a rotationally movable manner and including a trigger member with a rotary trigger cam, a trigger operating wheel, and a trigger output wheel, an operating device kinematically linked to the trigger operating wheel and configured to lock or release the trigger output wheel depending on the rotation of the trigger operating wheel, and a trigger lever configured to read the rotary trigger cam.

### TECHNICAL FIELD

The present invention relates to a triggering mechanism for triggering a clockwork mechanism arranged to perform a function.

The present invention also relates to a timepiece comprising such a triggering mechanism.

### PRIOR ART

The publication CH 717672 describes a mechanism for making it possible to trigger an animation disc, representing for example a shooting star. The control member is a ratchet wheel of a barrel of a watch movement rotated at least through an oscillating weight and possibly also through a working member which can be actuated by a user. Since the triggering mechanism is essentially managed by the ratchet wheel of the barrel which imposes a substantially constant torque, the triggering mechanism is systematically triggered to start the animation.

Document CH 717672 does not provide any information regarding the consequences on the triggering of the animation or on the mechanism in the event that a user wishes to trigger the animation at will by actuating the working member by applying a force which is insufficient or too high.

Document EP 2 068 210, which describes a triggering mechanism according to the preamble of the appended claim 1, is also known. This triggering mechanism makes it possible to transform a continuous movement, for example the continuous rotation of a wheel of an input wheel and pinion, into a periodic instantaneous trigger movement of an output wheel and pinion. No information is provided regarding whether an insufficient force or too great a force is applied to this triggering mechanism.

Furthermore, clockwork triggering mechanisms, which are based on other constructions and which are configured to be able to manage the application of an insufficient force to the control member by having a functionality called “all-or-nothing”, are known. This means that the action linked to the triggering mechanism is only triggered if the user applies a sufficient force to the control or working member. Such “all-or-nothing” mechanisms are described, for example, in documents EP 1959317 and CH 3873. The “all-or-nothing” mechanisms are typically based on pawl systems, the operation of which is not always optimal. In addition, these mechanisms do not make it possible to manage the application of too great a force to the control member.

Clockwork triggering mechanisms, which are configured to be able to manage the application of a very high force to the control member by the user by having a device guaranteeing a constant output torque of the triggering mechanism, are also known. Such mechanisms are described, for example, in documents EP 1960844 and CH 717359. However, these mechanisms do not make it possible to manage the application of too low a force to the control member.

The present invention aims to remedy these drawbacks by proposing a triggering mechanism for triggering a clockwork mechanism which makes it possible to manage the application of an insufficient force and too great a force to the control member equally well.

### Disclosure of the Invention

To this end, the invention relates to a triggering mechanism for triggering a clockwork mechanism arranged to perform a function, said triggering mechanism comprising:
a control device comprising a control member:
a trigger wheel and pinion mounted in a rotationally movable manner and comprising a trigger member intended to be rotated by the control member, a trigger operating wheel kinematically linked to the trigger member and integral in rotation with a first end of an elastic member, and a trigger output wheel integral in rotation with a second end of the elastic member and kinematically linked to an element of the clockwork mechanism, said trigger member being a rotary trigger cam,
an operating device kinematically linked to the trigger operating wheel and arranged to lock or release the trigger output wheel depending on the rotation of said trigger operating wheel, the control member being arranged to exert a first rotational driving force on said trigger cam.

According to the invention, said triggering mechanism comprises a trigger lever arranged to read the trigger cam and said trigger cam and the trigger lever are arranged to make it possible for said trigger lever, when reading said trigger cam rotated by the control member:
to store energy by exerting a second rotational driving force on said trigger cam, which is counteracting as long as the first rotational driving force is less than a predetermined threshold, and
to restore, beyond said predetermined threshold, said energy so that said second rotational driving force exerted on the trigger cam causes a rotation of the trigger operating wheel such that the operating device, locking the trigger output wheel until then, releases said trigger output wheel to perform said function.

The triggering mechanism according to the invention is thus of the “all-or-nothing” type by allowing the trigger output wheel to rotate, which will make it possible for the clockwork mechanism to only perform its function if the force applied to the control member is sufficient to cause a rotation of the trigger cam and therefore the rotation of the trigger operating wheel necessary for the actuation of the operating device to release the trigger output wheel in order to perform the function.

In addition, the triggering mechanism according to the invention advantageously constitutes an intermediate device which makes it possible to manage the force applied to the control member by standardising the torque to be transmitted to the associated clockwork mechanism to perform its function. The clockwork mechanism thus receives, from the trigger output wheel, a constant torque linked to the elastic member, which is independent of the force applied to the control member, in particular a very high force.

The trigger lever is advantageously provided with a return spring arranged to store and restore said energy when the trigger lever reads the rotating trigger cam, making it possible for said trigger lever to exert the second rotational driving force on the trigger cam.

The trigger cam preferably has n branches defining n tips and n valleys, each branch having a rising flank and a falling flank.

The return spring of the trigger lever is advantageously arranged to store said energy when the trigger lever reads a rising flank of the rotating trigger cam, and to restore said energy when the trigger lever reads a falling flank of the rotating trigger cam, making it possible for the trigger lever to exert the second rotational driving force on the trigger cam.

In order to exert the first rotational driving force on the trigger cam, the control member is advantageously a control lever which has a hook arranged to rotate said trigger cam, preferably by grasping a tip of one of its branches.

The trigger cam is advantageously coaxial and integral in rotation with the trigger operating wheel. This makes it possible to reduce the bulk of the mechanism.

The trigger lever preferably comprises a runner arranged to read the trigger cam. Such a runner makes it possible to reduce the friction and to make it easier to read the trigger cam.

The elastic member is preferably a spiral coiled spring.

The operating device advantageously comprises an operating pinion which can rotate freely and is kinematically linked to the trigger operating wheel, an operating cam integral with said operating pinion, an operating fork mounted in a rotationally movable manner and arranged to cooperate with the operating cam, an operating anchor integral in rotation with the operating fork, said operating anchor comprising two arms arranged to be able to alternately lock a locking finger integral in rotation with a locking pinion arranged to be kinematically linked to the trigger output wheel.

In a preferred embodiment, the clockwork mechanism is a correction mechanism of at least one display member, for example a correction mechanism of a display member linked to a GMT time.

The present invention also relates to a timepiece comprising a clockwork mechanism arranged to perform a function and a triggering mechanism for triggering said clockwork mechanism as defined above.

### BRIEF DESCRIPTION OF THE DRAWINGS

Other characteristics and advantages of the present invention will appear on reading the following detailed description of an embodiment of the invention which is provided as a non-limiting example, and with reference to the appended drawings, wherein:

FIG. 1 is an isometric view of a triggering mechanism according to the invention used in a timepiece for correcting display members linked to a GMT time;

FIG. 2 is an isometric view of the differential gear;

FIG. 3 is a sectional view of the differential gear of FIG. 2;

FIG. 4 is an isometric view of the phase-shift wheel and pinion;

FIG. 5 is an isometric view of the lower phase-shift wheel of the phase-shift wheel and pinion of FIG. 4;

FIG. 6 is a view of a display device arranged to display the difference between the local time HT and the GMT time used in the present invention;

FIG. 7 is an isometric view of the trigger wheel and pinion;

FIG. 8 is an isometric view of the trigger operating wheel of the trigger wheel and pinion of FIG. 7;

FIG. 9 is an isometric view of the operating device;

FIG. 10 is an isometric view of the operating pinion, the operating cam and the operating fork of the operating device of FIG. 9; and

FIGS. 11 to 14 are top views of the triggering mechanism according to the invention in different operating phases.

### EMBODIMENTS OF THE INVENTION

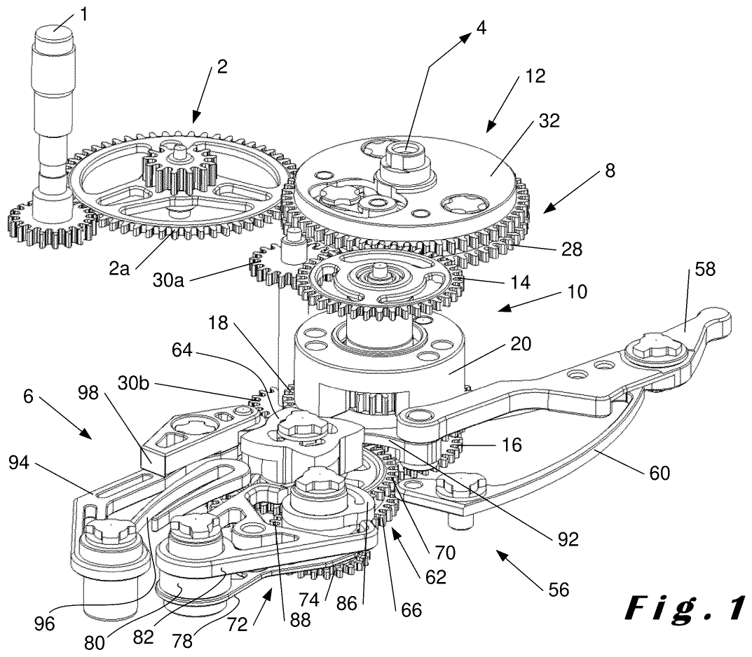

The present invention relates to a triggering mechanism for triggering a clockwork mechanism. In the exemplary embodiment described, said clockwork mechanism is a correction mechanism of a display member linked to a GMT time provided in a timepiece, the elements of which that are useful for understanding the invention are shown in FIG. 1.

Said timepiece comprises, in a known manner, a cannon-pinion 1 which integrally carries the minute display member (such as a hand, not shown), and which is kinematically linked to the drive organ (not shown) of the timepiece, such as a barrel. During the normal operation of the timepiece, in a conventional manner, the cannon-pinion 1 is driven via the drive organ and in turn drives, via a driving wheel and pinion 2 corresponding to the minute wheel and pinion, the hour wheel (not shown) which is arranged to drive a first local time HT display member (such as a hand, not shown) in cooperation with the minute display member.

The timepiece also comprises a second display member, symbolically represented by the reference 4, such as a hand, arranged to be able to display a GMT time of a time zone which is different to that of the local time HT.

It is obvious that any other suitable member for displaying the local time HT and the GMT time can be used.

The timepiece also comprises a correction mechanism 6 for the second display member 4 arranged to be able to correct the GMT time independently of the local time HT.

Said correction mechanism 6 will be described in more detail below.

The timepiece also comprises a driving mechanism 8 for the second display member 4 which comprises a differential gear 10 and a phase-shift wheel and pinion 12.

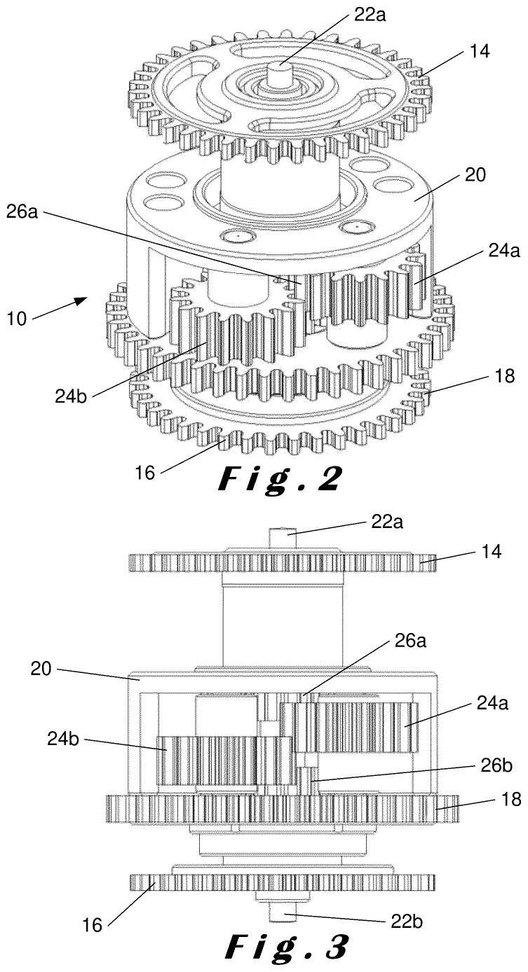

With reference more particularly to FIGS. 2 and 3, said differential gear 10 comprises at least one upper differential wheel and pinion 14 arranged to be kinematically linked to the second display member 4, a lower differential wheel and pinion 16 arranged to be kinematically linked to the driving wheel and pinion 2 of the first display member (minute wheel and pinion), by way of the phase-shift wheel and pinion 12 as described below, and an input 18 arranged to be kinematically linked to the correction mechanism 6 of the second display member 4.

More specifically, the differential gear 10 comprises a differential block 20 mounted such that it can rotate freely, preferably on two half-axes 22a, 22b pivotally mounted on the frame of the piece and integral respectively with the upper differential wheel and pinion 14 and the lower differential wheel and pinion 16. Said differential block 20 carries at least one first intermediate wheel 24a arranged to mesh with a pinion 26a which is integral with the half-axe 22a of the upper differential wheel and pinion 14 and a second intermediate wheel 24b arranged to mesh with a pinion 26b which is integral with the half-axis 22b of the lower differential wheel and pinion 16, said intermediate wheels 24a and 24b being mounted such that they can rotate freely on the differential block 20.

The differential block 20 is also integral with a wheel constituting the input 18 of the differential gear 10 and arranged to be kinematically linked to the triggering mechanism as will be described below.

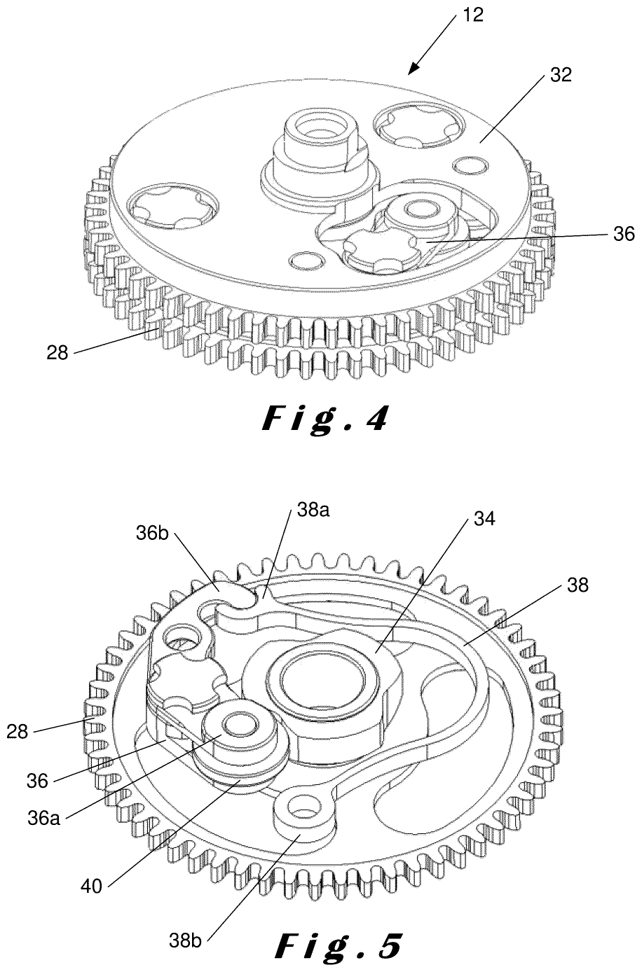

With reference more particularly to FIGS. 4 and 5, the phase-shift wheel and pinion 12 comprises a lower phase-shift wheel 28 arranged to be kinematically linked to the driving wheel and pinion 2 of the first display member and, more particularly, to the minute wheel 2a. The lower phase-shift wheel 28 is also arranged to be kinematically linked to the lower differential wheel and pinion 16 of the differential gear 10, for example by way of two stepped intermediate wheels 30a, 30b integral with each other, the pinion 30a being arranged to cooperate with the lower phase-shift wheel 28 and the pinion 30b being arranged to cooperate with the lower differential wheel and pinion 16, as shown in FIG. 1.

The phase-shift wheel and pinion 12 also comprises an upper phase-shift wheel 32, coaxial with the lower phase-shift wheel 28, and arranged to drive the second display member 4 and to be kinematically linked to the upper differential wheel and pinion 14 of the differential gear 10.

The upper phase-shift wheel 32 is also kinematically linked to the lower phase-shift wheel 28 in a disengageable manner so that said upper phase-shift wheel 32 is uncoupled from the lower phase-shift wheel 28 during a correction of the GMT time independently of the local time HT by the correction mechanism 6 while making possible, following correction, a repositioning of the second display member 4 synchronised with the positioning of the first display member.

The upper phase-shift wheel 32 is kinematically linked to the lower phase-shift wheel 28 in a disengageable manner by means of a phasing cam 34 integral with the lower phase-shift wheel 28, coaxial with said lower phase-shift wheel 28, and a hammer 36 equipped with a phase-shift spring 38 carried by the upper phase-shift wheel 32, said hammer 36 being arranged to cooperate with said phasing cam 34.

More particularly, the hammer 36 is pivotally mounted on the upper phase-shift wheel 32 by means of a pivot axis mounted integrally on said upper phase-shift wheel 32.

The hammer 36 comprises a first end 36a provided with a runner 40 cooperating with the phasing cam 34 to facilitate its reading, and a second end 36b which cooperates with a first end 38a of the phase-shift spring 38. The second end 38b of the phase-shift spring 38 is pivotally mounted on the upper phase-shift wheel 32 by means of a pivot axis mounted integrally on said upper phase-shift wheel 32.

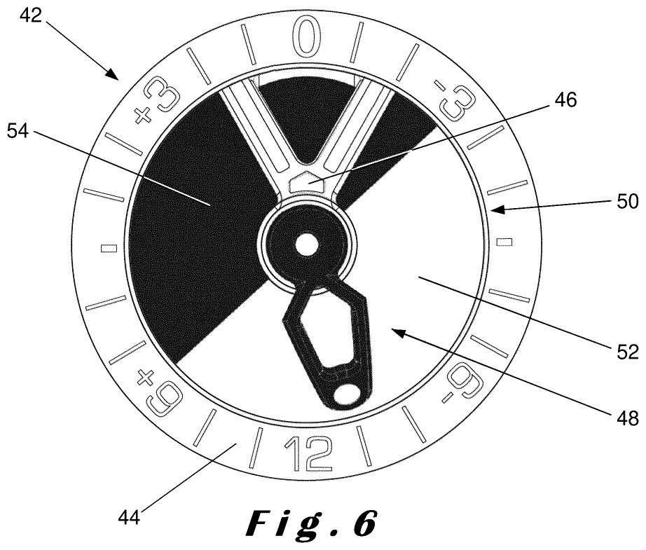

The timepiece can also comprise a display device 42 shown in FIG. 6, arranged to display the difference between the local time HT and the GMT time.

Said display device 42 comprises a fixed dial 44, an indicator 46 fixedly mounted on the dial 44 and arranged to define the local time HT as a reference, and a third display member 48 mounted in a rotatably movable manner with respect to said dial 44 in order to be able to move it, the position of the third display member 48 on the dial 44 with respect to the indicator 46 indicating the difference between the local time HT and the GMT time. In operating mode, the third display member 48 is fixed. The dial 44 includes graduations to indicate, by means of the third display member 48, the time zone difference between the local time HT and the GMT time. For example, the fixed dial 44 can be graduated from 0 to −12 on one side of the 0 indicated by the fixed indicator 46 and from 0 to +12 on the other side of the 0, making it possible to indicate the time zone difference from 0 hrs to 12 hrs directly to the user in one direction or the other by means of the third display member 48. In the example of FIG. 6, the third display member 48 indicates a difference of −11 hrs on the dial 44 informing the user that the local time HT is 11 hrs ahead of the GMT time.

Said display device 42 can also comprise a day/night disc 50 comprising two angular sectors 52 and 54 extending on either side of an axis of symmetry of the disc over 180°. The disc 50 is driven in the clockwork direction by the watch movement of the timepiece by one revolution for every 24 hours. The position of the indicator 46 and of the third display member 48 above the day/night disc 50 makes it possible to indicate, at a given moment, whether it is day or night respectively at local time HT and at GMT time.

Such a display device 42 is described in the applicant's application CH 2021/0070690.

To make it possible to correct the difference between the local time HT and the GMT time displayed during a correction of the second GMT time display member 4, that is to say a correction of the third display member 48, independently of the local time HT, the display device 42, and more particularly said third display member 48, is kinematically linked to the triggering mechanism, as will be detailed below, in order to be able to be corrected by the correction mechanism 6 of the second display member 4.

The correction mechanism 6 of the second display member 4 comprises a triggering mechanism 56.

With reference to FIG. 1, and 7 to 10, said triggering mechanism 56 comprises a control device comprising a control member 58 intended to be accessible to a user via, for example, a pushbutton, to perform the function of the associated clockwork mechanism, here the function of correcting the second GMT time display member 4 and, if present, of the third display member 48 indicating the time zone difference between the local time HT and the GMT time, independently of the local time HT.

The control member 58 is advantageously a control lever pivotally mounted on the frame and equipped with its return spring 60. The control lever is set in motion by the user via, for example, a pushbutton (not shown).

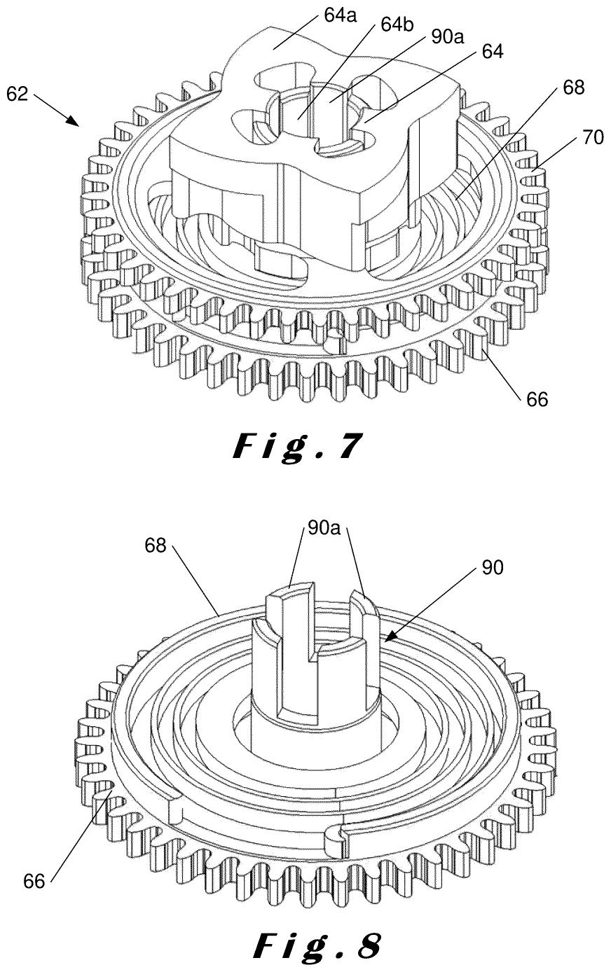

The triggering mechanism 56 also comprises a trigger wheel and pinion 62, visible in particular in FIG. 7, arranged to be mounted in a rotatably movable manner on the frame of the piece. The trigger wheel and pinion 62 comprises a trigger member 64 intended to be rotated, directly or indirectly, by the control member 58, a trigger operating wheel 66 kinematically linked to the trigger member 64 and integral in rotation with a first end of an elastic member 68, and a trigger output wheel 70 integral in rotation with a second end of the elastic member 68 and kinematically linked to an element of the clockwork mechanism to be triggered. The elastic member is advantageously a spiral coiled spring.

In the example described, the trigger output wheel 70 is kinematically linked to the wheel constituting the input 18 of the differential gear 10 to make it possible to correct the second GMT time display member 4 independently of the local time HT. If the third display member 48 is present, the trigger output wheel 70 is also kinematically linked to said third display member 48 to make it possible to correct said third display member 48 at the same time as the second display member 4 is corrected.

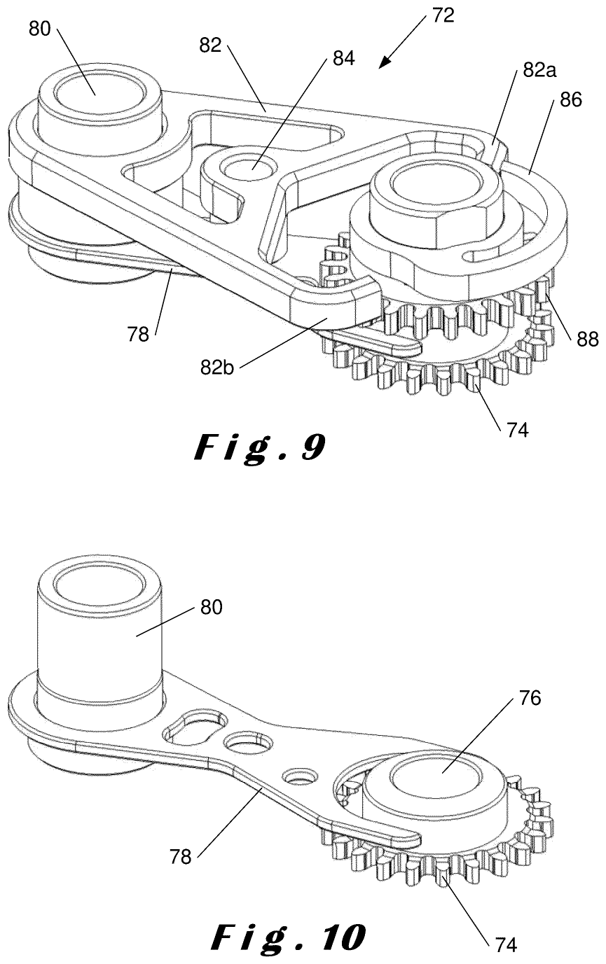

The triggering mechanism 56 also comprises an operating device 72, shown in FIGS. 9 and 10, kinematically linked to the trigger operating wheel 66 and arranged to lock or release the trigger output wheel 70 depending on the rotation of said trigger operating wheel 66.

The operating device 72 advantageously comprises an operating pinion 74 mounted such that it can rotate freely on the frame and arranged to be kinematically linked to the trigger operating wheel 66.

The operating device 72 also comprises an operating cam 76 integral with said operating pinion 74 and constituting an eccentric member with respect to the operating pinion 74, more particularly with respect to its axis of rotation. The operating device 72 additionally comprises an operating fork 78 which is mounted in a rotationally movable manner on the frame about an axis 80 and arranged to cooperate with said operating cam 76 in order to be pivoted alternately in one direction or the other.

The operating device 72 also comprises an operating anchor 82 which is mounted in a rotationally movable manner on the axis 80 and arranged to be integral in rotation with the operating fork 78 by means of, for example, a post 84 integral with the operating anchor 82 and the operating fork 78, said operating anchor 82 comprising two arms 82a, 82b arranged to be able to alternately lock a locking finger 86 integral in rotation with a locking pinion 88 mounted such that it rotates freely on the frame and arranged to be kinematically linked to the trigger output wheel 70. When the locking finger 86 is locked by one of the arms 82a, 82b, the locking pinion 88 is locked and prevents the rotation of the trigger output wheel 70. When the operating anchor 82 pivots, releasing the locking finger 86, the locking pinion 88 rotates freely and releases the trigger output wheel 70 to make it possible for it to rotate under the effect of the energy released by the elastic member 68.

The operating pinion 74, the locking finger 86 and the locking pinion 88 are advantageously aligned along a same axis.

The trigger member 64 is advantageously a rotary trigger cam. Said trigger cam 64 preferably has n branches 64a defining n tips and n valleys. To this end, each of the branches 64a comprises a rising flank and a falling flank. In the example as shown, the trigger cam comprises four branches 64a.

The trigger cam 64 is advantageously coaxial and integral in rotation with the trigger operating wheel 66. The trigger cam 64 can be made integral with the trigger operating wheel 66 by means of, for example, a cylindrical counter-form 90 integral with the trigger operating wheel 66 and coaxial with the trigger cam 64 and the trigger operating wheel 66. The counter-form 90 comprises four catches 90a, as shown in FIG. 8 and is arranged to fit into a corresponding opening 64b provided at the centre of the trigger cam 64, the catches 90a bearing against the inner wall of the opening 64b.

The trigger output wheel 70 is mounted such that it can rotate freely on the counter-form 90, between the trigger cam 64 and the trigger operating wheel 66, coaxially with said trigger cam 64 and with said trigger operating wheel 66. The spiral coiled spring 68 is positioned between the trigger output wheel 70 and the trigger operating wheel 66, one of its ends being integral with the trigger output wheel 70, its other end being integral with the trigger operating wheel 66.

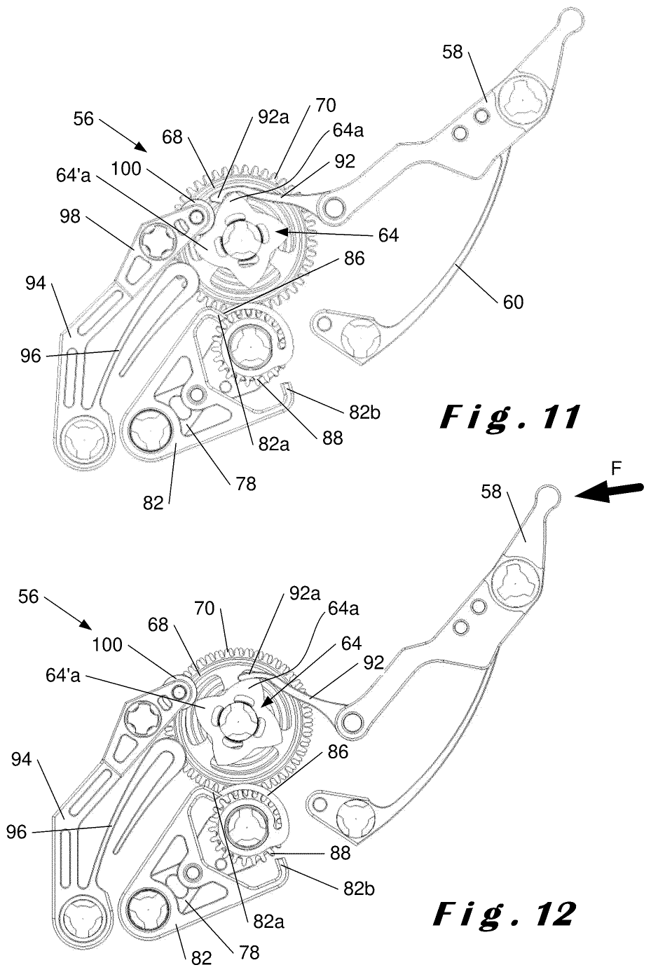

The control member 58, here the control lever, is advantageously arranged to exert a first rotational driving force, directly or indirectly, on said trigger cam 64, making it possible to initiate the rotation of said trigger cam 64. To this end, the control lever advantageously has, on the side of its end which cooperates with the trigger cam 64, an arm 92, visible in FIGS. 1 and 11 in particular, pivotally mounted on said control lever 58 and terminated at its free end by a hook 92a (see FIG. 11). Said hook 92a is arranged to rotate said trigger cam 64, for example by grasping a tip of one of its branches 64a. As will be seen below, the hook 92a more particularly makes it possible to exert a first driving force on said trigger cam 64, making it possible to initiate the rotation of said trigger cam 64.

The triggering mechanism 56 advantageously also comprises a trigger lever 94 pivotally mounted on the frame, and arranged to read the trigger cam 64 by way of a reading member. The trigger cam 64 and the trigger lever 94 are arranged to make it possible for the trigger lever 94, when it reads said trigger cam 64, the rotation of which is initiated by the control member 58, here the control lever:
to store energy by exerting a second rotational driving force on said trigger cam 64, which is counteracting as long as the first rotational driving force is less than a predetermined threshold, and
to restore, beyond said predetermined threshold, said energy so that said second rotational driving force exerted on the trigger cam 64 makes it possible to terminate the rotation of the trigger cam 64 by causing a rotation of the trigger operating wheel 66 such that the operating device 72, locking the trigger output wheel 70 until then, releases said trigger output wheel 70 to perform said function. To this end, the trigger lever is advantageously provided with a return spring 96 arranged to store and restore said energy when the trigger lever 94 reads the rotating trigger cam 64, making it possible for said trigger lever 94 to exert said second rotational driving force on the trigger cam 64.

More particularly, the return spring 96 is arranged to store said energy when the trigger lever 94 reads a rising flank of a branch 64a′ of the rotating trigger cam, and to restore this energy when the trigger lever 94 reads the falling flank of the branch 64a′ of the rotating trigger cam 64, making it possible for the trigger lever 94 to exert the second rotational driving force on said trigger cam 64.

To this end, the trigger lever 94 advantageously has, on the side of its end which cooperates with the trigger cam 64, an arm 98, visible in FIGS. 1 and 11 in particular, having at its free end a runner 100 (see FIG. 11) constituting the reading member arranged to read the trigger cam 64 by following the rising flank and the falling flank of each branch 64a.

The various elements of the triggering mechanism 56 are dimensioned and configured so that the function linked to the clockwork mechanism is only performed when said control lever 58 exerts a first necessary and sufficient rotational driving force which is at least equal to a predetermined threshold fixed by the construction of the elements of the triggering mechanism 56 on the trigger cam 64, and in particular dependent on the force of the return spring 96. The rotation of said trigger cam 64 is such that, when the trigger lever 94 reads a rising flank of one of the branches 64a of the rotating trigger cam 64, the return spring 96 of the trigger lever 94 is wound and stores energy. This energy is then restored when the trigger lever 94 reads a falling flank of said branch 64a of the rotating trigger cam 64, thus making it possible for the trigger lever 94 to exert a second rotational driving force on the trigger cam 64 to drive the trigger cam 64 in a complementary rotation phase with the trigger operating wheel 66 associated therewith. In this manner, the operating device 72 which locked the trigger output wheel 70 is actuated so as to release said trigger output wheel 70 and to allow it to rotate, driven by the energy released by the elastic member 68, in order to perform the function.

In connection more specifically with the correction mechanism 6 of the second GMT time display member 4 and, if present, of the third display member 48 indicating the time zone difference between the local time HT and the GMT time, independently of the local time HT, described above, the operation of the correction mechanism 6 and of its triggering mechanism 56 is described below with reference to FIGS. 11 to 14.

During the normal operation of the timepiece, the triggering mechanism 56 is in the resting state as shown in FIG. 11. In this initial resting state, the triggering mechanism 56 is such that the runner 100 of the trigger lever 98 is positioned in a stable resting position in a valley at the foot of a rising flank towards the tip of one of the branches 64a′ of the trigger cam 64. The hook 92a of the control lever is preferably positioned at the tip of one of the branches 64a of the trigger cam 64. The locking finger 86 is locked by the arm 82a of the operating anchor 82 of the operating device 72 so that the trigger output wheel 70 is locked in rotation, retained by the locking pinion 88.

The drive organ of the timepiece drives the cannon-pinion 1 which, in turn, drives the minute display member as well as the hour wheel, via the minute wheel and pinion 2. The hour wheel drives the first local time HT display member in a standard manner. The minute wheel 2a also drives the lower phase-shift wheel 28 of the phase-shift wheel and pinion 8, as well as the upper phase-shift wheel 32, then coupled to the lower phase-shift wheel 28 by the phasing cam 34/hammer 36 assembly. The second GMT time display member 4 is then driven in a synchronised manner with the first local time HT display member. In this state, the lower phase-shift wheel 28 continuously drives the lower differential wheel and pinion 16 of the differential gear 10 by way of two stepped intermediate wheels 30a, 30b and the upper phase-shift wheel 32 continuously drives the upper differential wheel and pinion 14 of the differential gear 10. Since the input wheel 18 of the differential gear 10 is locked by the triggering mechanism 56, the differential block 20 does not turn. The intermediate wheels 24a and 24b are also continuously driven by way of the pinions 26a, 26b integral with their respective half-axis 22a, 22b. Since the trigger output wheel 70 is locked, the third display member 48 remains fixed.

During a correction of the second display member 4 and, if present, of the third display member 48, independently of the local time HT, the user actuates the control member 58, here the control lever, via for example a pushbutton of the control device according to a force F shown in FIG. 12 by an arrow. When the control lever pivots, its hook 92a grasps the tip of the branch 64a of the trigger cam 64 to initiate and rotate said trigger cam 64. During this rotation of the trigger cam 64, the runner 100 of the trigger lever 94 reads said trigger cam 64 by following the rising flank of another branch 64a′ of the trigger cam 64, which has the effect of winding the return spring 96 of the trigger lever 94. At the same time, the rotation of the trigger cam 64 rotates the trigger operating wheel 66 which is integral therewith, which has the effect of winding the triggering spring 68 which can potentially be pre-wound, the trigger output wheel 70 still being locked by the operating device 72. Indeed, during this winding phase, the elements of the triggering mechanism 56 are dimensioned so that the rotation of the trigger operating wheel 66 causes a rotation of the operating pinion 74 and its operating cam 76 and, therefore, of the operating fork 78 and the operating anchor 82 but not sufficiently for the arm 82a to release the locking finger 86, as shown in FIG. 12.

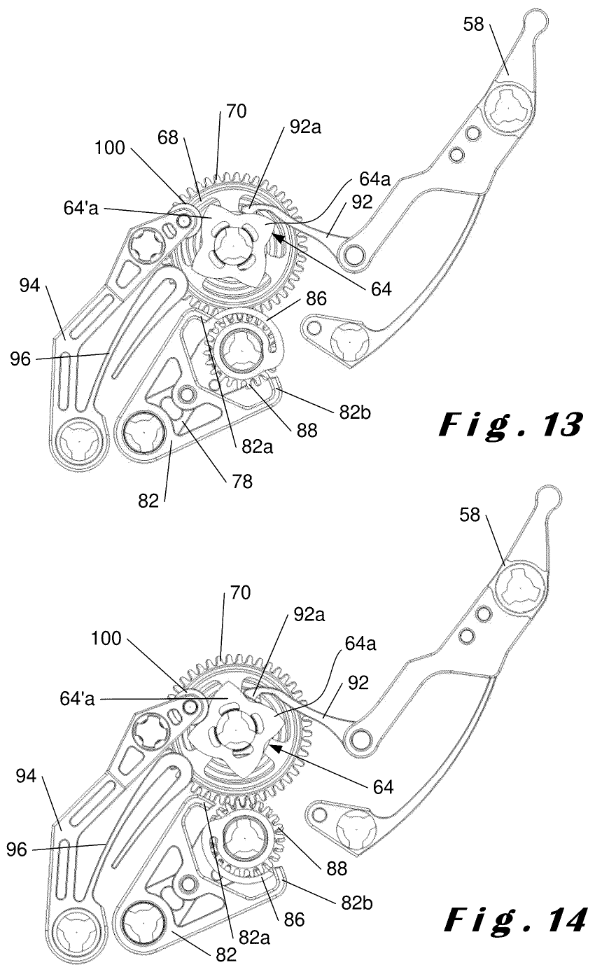

During the following triggering phase shown in FIG. 13, the runner 100 of the trigger lever 94 continues to read the trigger cam 64, which continues its rotation, passing the tip of the branch 64a′ and following the falling flank of said branch 64a′ of the trigger cam 64, so that the return spring 96 of the trigger lever 94 redistributes the stored energy to the trigger lever 94 which becomes the motor of the trigger cam 64. As the rotation of the trigger cam 64 continues, the triggering spring 68 continues to wind itself.

The elements of the triggering mechanism 56 are dimensioned so that when the runner 100 falls along the flank of the trigger cam 64, the rotation of said trigger cam 64 and of the trigger operating wheel 66 has caused a sufficient rotation of the operating pinion 74, its operating cam 76, the operating fork 78 and the operating anchor 82 so that the arm 82a has pivoted sufficiently to disengage from the locking finger 86 and to release it, as shown in FIG. 13.

Since the locking finger 86 is released, the locking pinion 88 is free to pivot so that it no longer locks the trigger output wheel 70 which is released. Said trigger output wheel 70 is then rotated under the effect of the energy stored by the triggering spring 68.

When the third display member 48 indicating the time zone difference between the local time HT and the GMT time is present, the rotation of the released trigger output wheel 70 directly drives the third display member 48 kinematically linked to said trigger output wheel 70 in order to correct it, in order to move the third display member 48 by steps until the desired time zone difference is displayed on the dial 44. In parallel, the rotation of the released trigger output wheel 70 rotates the input wheel 18 of the differential gear 10 to perform the correction of the second display member 4.

To this end, the rotation of the input wheel 18 of the differential gear 10 rotates the differential block 20 so that the intermediate wheel 24a, respectively 24b, rotates the half-axis 22a, respectively 22b, via the pinion 26a, respectively 26b, and therefore rotates the upper differential wheel and pinion 14 and the lower differential wheel and pinion 16 respectively. The lower differential wheel and pinion 16 then constitutes a first output of the differential gear 10 kinematically linked to the lower phase-shift wheel 28 of the phase-shift wheel and pinion 12 and to the minute wheel and pinion 2. The rotation of the lower differential wheel and pinion 16 makes it possible to take up the gear play of the differential gear 10 up to the cannon-pinion 1 in order to then be locked. This locking compels the upper differential wheel and pinion 14 to drive the upper phase-shift wheel 32 by constituting the second output of the differential gear 10 kinematically linked to the upper phase-shift wheel 32 of the phase-shift wheel and pinion 12. The rotation of the upper differential wheel and pinion causes the upper phase-shift wheel 32 to be disengaged from the lower phase-shift wheel 28 thanks to the phasing cam 34/hammer 36 assembly, the rotation of the upper phase-shift wheel 32 rotating the second display member 4 in order to correct it.

The differential block 20 turns by steps by an angle defined by the trigger cam 64 and its gear ratio with the trigger output wheel 70. These steps define the offset of the third display member 48 indicating, here, the time zone difference between the local time HT and the GMT time, and the phase-shift angle of the phase-shift wheel and pinion 12 in order to correct the second GMT time display member 4. In the phase-shift wheel and pinion 12, the correction angle of the upper phase-shift wheel 32 corresponds to one step of the phasing cam 34.

The correction mechanism 6 thus makes it possible to perform a correction by steps of the second GMT time display member 4, and simultaneously of the third display member 48 if it is present, independently of the local time HT, that is to say independently of the first local time HT display member and of the minute display member.

The phasing cam 34/hammer 36 assembly of the phase-shift wheel and pinion 12 makes it possible to precisely reposition the second GMT time display member 4 with respect to the position of the first display member following each correction of said second display member 4. Indeed, by leaving one valley of the phasing cam 34 to precisely reposition itself in the following valley, the runner 40 of the hammer 36 mounted on the upper phase-shift wheel 32 of the phase-shift wheel and pinion 12 is positioned so that the position of said second GMT time display member 4 remains perfectly synchronised with the position of the first local time HT display member with respect to the position of the minute display member.

The phase-shift wheel and pinion 12 also advantageously makes it possible to take up the play of the differential gear 10 to avoid too much play between the minute wheel and pinion 2 and the indication operated by the upper phase-shift wheel 32, here the second GMT time display member 4. In addition, since the indication is operated by the upper phase-shift wheel 32 of the phase-shift wheel and pinion 12, the latter also makes it possible to avoid continuously conveying torque into the differential gear 10 in order to drive said indication.

Following the unlocking of the locking finger 86, the trigger lever 94 continues its repositioning in the valley of the trigger cam 64. In order to increase the energy supplied for unlocking the phase-shift of the phase-shift wheel and pinion 12, it might be possible to provide a rigid link (with an eyelet and a pin, for example) between the trigger operating wheel 66 and the trigger output wheel 70 during this triggering phase.

In parallel during this triggering phase, the control lever finishes its movement (still under the effect of the user) until it comes against a stop (not shown) to no longer supply energy to the trigger cam 64.

During the following locking phase shown in FIG. 14, the locking finger 86, which has pivoted with the locking pinion 88 during the correction phase, comes into abutment on the other arm 82b of the operating anchor 82 once the phase-shift has been realised. The trigger output wheel 70 is locked again. The locking of the locking finger 86 by the operating anchor 82 is done alternately by the arm 82a and the arm 82b each time the control member 58 is actuated sufficiently for the performance of the associated function.

When the user releases the pushbutton of the control member 58, here the control lever, the hook 92a of the control lever comes to reposition itself in the valley behind the branch 64a of the trigger cam 64 (namely, downstream of the branch 64a), ready to grasp the tip of the following branch 64a′, as shown in FIG. 14. The runner 100 of the trigger lever 94 returns to its stable resting position in the valley behind the branch 64a′.

It is easily understood that if the user does not apply a sufficient force to the control member 58, no correction takes place, since the correction mechanism is not triggered. Indeed, as described above, the various elements of the triggering mechanism 56 are dimensioned and configured so that a first rotational driving force of the control lever 58 exerted on the trigger cam 64, which is greater than or equal to the predetermined threshold, generates a second rotational driving force exerted by the trigger lever 94. This second driving force makes it possible to obtain a necessary and sufficient rotation of said trigger cam 64 (and therefore of the associated trigger operating wheel 66, of the operating pinion 74, of its operating cam 76, of the operating fork 78 and of the operating anchor 82) in order to release the locking finger 86 and thus the trigger output wheel 70 in order to perform the function, here the correction by steps of the second GMT time display member 4, and of the third display member 48 if it is present, independently of the local time HT.

If the force applied by the user is too weak, the first rotational driving force exerted by the control lever will be less than the predetermined threshold of the driving force, which drives a necessary and sufficient rotation of said trigger cam 64 in order to release the locking finger 86, so that the rotation of the operating anchor 82 will not be sufficient to release the locking finger 86. Consequently, the trigger output wheel 70 will remain locked and it will not be possible for the function to be performed.

If the force applied by the user is sufficient for the first rotational driving force exerted by the control lever to be greater than or equal to the predetermined threshold of the necessary and sufficient rotational driving force, the rotation of the trigger cam 64 will be sufficient for the operating anchor 82 to pivot sufficiently to release the locking finger 86 and thus the trigger output wheel 70 so as to perform the function.

The triggering mechanism of the invention is therefore of the “all-or-nothing” type, allowing the rotation of the trigger output wheel 70 which will make it possible for the clockwork mechanism to only perform its function if the force applied to the control member 58 is sufficient to cause a rotation of the trigger cam 64 and therefore the rotation of the trigger operating wheel 66 necessary for the actuation of the operating device 72 in order to release the trigger output wheel 70.

In addition, the triggering mechanism 56 according to the invention advantageously constitutes an intermediate device which makes it possible to manage the force applied to the control member 58 by standardising the torque to be transmitted to the clockwork mechanism to perform its function. Thus, the clockwork mechanism receives, from the trigger output wheel 70, a constant torque linked to the characteristics of the elastic member 68, independent of the force applied to the control member 58 by the user. In particular, even if the user applies a very high force to the pushbutton, he cannot provide momentum to said clockwork mechanism.

The triggering mechanism according to the present invention thus makes it possible to manage, equally well, the application to the control member 58 of an insufficient force, by being of the “all-or-nothing” type, and of too great a force, by making it possible to perform the function “at constant force”.

The advantage of the triggering mechanism according to the present invention is that the user provides the necessary impulse to trigger the mechanism and that it is said mechanism which then performs the function itself. The user cannot thus provide momentum to the correction mechanism, even if he presses heavily on the pushbutton.

In addition, the use of the rotary locking finger 86 between two stops constituted by the arms 82a, 82b of the operating anchor 82 and of the locking pinion 88 integral with the locking finger 86 makes it possible to precisely control the rotational angles of the correction geartrain when correcting the second GMT time display member 4, and the third display member 48, if it is present, independently of the local time HT. This makes it possible to reinforce the precision of the repositioning of the second GMT time display member 4 and of the third display member 48 if present, following their correction.

The example described above is related to a correction mechanism of a display member linked to a GMT time. It is obvious that the triggering mechanism according to the invention can be used in a clockwork mechanism arranged to perform another function, said clockwork mechanism being, for example, a mechanical animation arranged to be triggered on demand by the user and operated by the upper phase-shift wheel 32 of the phase-shift wheel and pinion 12.

1. A triggering mechanism for triggering a clockwork mechanism configured to perform a function, said triggering mechanism comprising:
a controller comprising a control member;
a trigger wheel and pinion mounted in a rotationally movable manner, the trigger wheel and pinion comprising
a trigger member configured to be rotated by the control member the trigger member being a rotary trigger cam, the control member being configured to exert a first rotational driving force on the rotary trigger cam,
a trigger operating wheel kinematically linked to the trigger member and integral in rotation with a first end of an elastic member and
a trigger output wheel integral in rotation with a second end of the elastic member and kinematically linked to an element of the clockwork mechanism,
an operating device kinematically linked to the trigger operating wheel and configured to lock or release the trigger output wheel depending on the rotation of said trigger operating wheel; and
a trigger lever configured to read the rotary trigger cam said rotary trigger cam and the trigger lever being configured to enable the trigger lever when the trigger lever reads said rotary trigger cam rotated by the control member to:
store energy by exerting a second rotational driving force on said trigger cam, which is counteracting as long as the first rotational driving force is less than a predetermined threshold, and
restore, beyond said predetermined threshold, said energy so that said second rotational driving force exerted on the rotary trigger cam causes a rotation of the trigger operating wheel such that the operating device, locking the trigger output wheel until then, releases said trigger output wheel to perform said function.

2. The triggering mechanism according to claim 1, wherein the trigger lever is provided with a return spring configured to store and restore said energy when the trigger lever reads the rotary trigger cam, enabling said trigger lever to exert the second rotational driving force on the rotary trigger cam.

3. The triggering mechanism according to claim 1, wherein the rotary trigger cam has n branches defining n tips and n valleys, each of the branches having a rising flank and a falling flank.

4. The triggering mechanism according to claim 2, wherein the return spring of the trigger lever is configured to store said energy when the trigger lever reads a rising flank of the rotary trigger cam and to restore said energy when the trigger lever reads a falling flank of the rotary trigger cam, enabling the trigger lever to exert the second rotational driving force on the rotary trigger cam.

5. The triggering mechanism according to claim 3, wherein, in order to exert the first rotational driving force on the rotary trigger cam, the control member is a control lever which has a hook configured to rotate said rotary trigger cam.

6. The triggering mechanism according to claim 1, wherein the rotary trigger cam is coaxial and integral in rotation with the trigger operating wheel.

7. The triggering mechanism according to claim 1, wherein the trigger lever comprises a runner configured to read the rotary trigger cam.

8. The triggering mechanism according to claim 1, wherein the elastic member is a spiral coiled spring.

9. The triggering mechanism according to claim 1, wherein the operating device comprises
an operating pinion which rotates freely and is kinematically linked to the trigger operating wheel,
an operating cam integral with said operating pinion,
an operating fork mounted in a rotationally movable manner and configured to cooperate with the operating cam,
an operating anchor integral in rotation with the operating fork, said operating anchor comprising two arms configured to alternately lock a locking finger integral in rotation with a locking pinion configured to be kinematically linked to the trigger output wheel.

10. The triggering mechanism according to claim 1, wherein the clockwork mechanism is a correction mechanism of at least one display member.

11. A timepiece comprising:
a clockwork mechanism configured to perform a function; and
the triggering mechanism configured to trigger said clockwork mechanism according to claim 1.

12. The timepiece according to claim 11, further comprising:
at least one first display member configured to display a local time;
a driving wheel and pinion of the at least one first display member;
a second display member configured to display another time of a different time zone than a time zone of the local time;
a driving mechanism of the second display member; and
a correction mechanism of the second display member configured to correct the other time independently of the local time, said correction mechanism comprising said triggering mechanism.

13. The timepiece according to claim 12, wherein the driving mechanism of the second display member comprises a differential gear which includes
at least one upper differential wheel and pinion configured to be kinematically linked to the second display member,
a lower differential wheel and pinion configured to be kinematically linked to the driving wheel and pinion of the at least one first display member, and
an input configured to be kinematically linked to the correction mechanism of the second display member.

14. The timepiece according to claim 13, wherein the differential gear comprises a differential block mounted such that it the differential block is configured to rotate freely on two half-axes respectively integral with the upper differential wheel and pinion and the lower differential wheel and pinion, said differential block carrying at least one first intermediate wheel configured to mesh with an upper pinion integral with the half-axis of the upper differential wheel and pinion and a second intermediate wheel configured to mesh with a lower pinion integral with the half-axis of the lower differential wheel and pinion, said differential block being integral with a wheel constituting the input of the differential gear configured to be kinematically linked to the trigger output wheel of the triggering mechanism.

15. The timepiece according to claim 13, wherein the driving mechanism of the second display member comprises
a phase-shift wheel and pinion comprising
a lower phase-shift wheel configured to be kinematically linked to the driving wheel and pinion of the first display member and to be kinematically linked to the lower differential wheel and pinion, and
an upper phase-shift wheel configured to drive said second display member and to be kinematically linked to the upper differential wheel and pinion, said upper phase-shift wheel being kinematically linked to the lower phase-shift wheel in a disengageable manner so that said upper phase-shift wheel is uncoupled from the lower phase-shift wheel when the other time is corrected independently of the local time by the correction mechanism while enabling, following correction, repositioning the second display member synchronized with positioning of the at least one first display member.

16. The timepiece according to claim 15, wherein the phase-shift wheel and pinion comprises
a phasing cam integral with the lower phase-shift wheel, and
a hammer equipped with a phase-shift spring carried by the upper phase-shift wheel, said hammer being configured to cooperate with said phasing cam.

17. The timepiece according to claim 12, further comprising a display device configured to display a difference between the local time and the other time, said display device being kinematically linked to the trigger output wheel of the triggering mechanism in order to be corrected during a correction of the second display member independently of the local time, by the correction mechanism of the second display member.

18. The triggering mechanism according to claim 3, wherein the return spring of the trigger lever is configured to store said energy when the trigger lever reads a rising flank of the rotary trigger cam, and to restore said energy when the trigger lever reads a falling flank of the rotary trigger cam, enabling the trigger lever to exert the second rotational driving force on the rotary trigger cam.

19. The triggering mechanism according to claim 4, wherein, in order to exert the first rotational driving force on the rotary trigger cam, the control member is a control lever which has a hook configured to rotate said rotary trigger cam.

20. The triggering mechanism according to claim 5, wherein the hook rotates said trigger cam by grasping a tip of one of the branches.
